(19) United States
(12) Patent Application Publication
(10) Pub. No.: US 2022/0319171 A1
(43) Pub. Date: Oct. 6, 2022

(54) System for Distributed Video Analytics

(71) Applicant: Aplicata Technologies, Inc., Burnaby (CA)

(72) Inventors: Mohammad Darwish, Vancouver (CA); Paul Russell, Vancouver (CA); Vispi Cassod, Monroe Twp, NJ (US); Hassan Sawaf, Log Gatos, CA (US)

(21) Appl. No.: 17/657,444

(22) Filed: Mar. 31, 2022

Related U.S. Application Data
(60) Provisional application No. 63/169,598, filed on Apr. 1, 2021.

(51) Int. Cl. G06V 20/40; H04N 19/85

(52) U.S. Cl. CPC G06V 20/44; G06V 20/46; H04N 19/85; G06V 20/49

(57) ABSTRACT

In one embodiment, a video analytics system includes a camera network for capturing one or more videos and an EVA (electronic video analytics) platform, coupled to the camera network, operable to perform one or more of video aggregation, encryption, storage and analysis. The EVA platform has a content store for storing videos of the one or more captured videos, an event detection engine for defining one or more events that are each assigned a unique key when encountered in a video of the one or more captured videos, an aggregator for aggregating event-containing videos, and a renderer for rendering the event-containing videos.

### CROSS-REFERENCE TO RELATED APPLICATION

This application claims priority from U.S. Provisional Patent Application No. 63/169,598 filed on Apr. 1, 2021, the disclosure of which is incorporated herein by reference in its entirety.

### TECHNICAL FIELD

The present disclosure relates generally to video capture and analytics.

### BACKGROUND

The increasing need for providing a secured environment in private and public places is driving the use of video capture and surveillance. Technological advancements have resulted in the availability of a variety of high-resolution, high-quality surveillance cameras that fulfill the varying requirements of applications.

A high definition video recording can be very helpful for all types of investigations because it provides accurate representation of events. However, it is unrealistic to store large amounts of video for extended periods due to the sheer cost of video storage, especially in large surveillance deployments. Moreover, depending on the timing of an event and the length of recording, reviewing video footage could be time consuming and prone to error.

### Overview

Recent improvements in artificial intelligence are paving the way for new approaches to dealing with the complexities of video capture and surveillance. One approach is to turn the camera into a smart video analytics tool that generates event notifications and performs other processing. Another approach is to perform post-recording event analysis using dedicated appliances or cloud computing, or a combination of these. Such approaches need the ability to adapt to varying requirements, and to take into account the cost of computing required for real-time analytics. A programmable system, in the form of a “software defined camera,” can provide this ability and many other advantages.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a general overview of a system for distributed video analytics in accordance with certain embodiments;

FIG. 2 is a cloud service system diagram of a distributed video analytics systems in accordance with certain embodiments;

FIG. 3 is a block diagram of showing some components of an electronica video analytics (EVA) platform in accordance with certain embodiments;

FIG. 4 is a block diagram of a programmable camera in accordance with certain embodiments;

FIG. 5 is a block diagram showing the use of events and keys used in relevant video portion identification; and

FIG. 6 is a flow diagram performed by a system for distributed video analytics in accordance with certain embodiments.

### DESCRIPTION OF EXAMPLE EMBODIMENTS

Example embodiments are described herein in the context of hardware and software for a system for distributed video analytics in accordance with certain embodiments. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines that may for instance use GPUs and CPUs. Devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium and other types of program memory.

Herein, reference to a computer-readable or machine-readable storage medium encompasses one or more non-transitory, tangible storage media possessing structure. As an example and not by way of limitation, a computer-readable storage medium may include a semiconductor-based circuit or device or other IC (such, as for example, a field-programmable gate array (FPGA) or an ASIC), a hard disk, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, nonvolatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

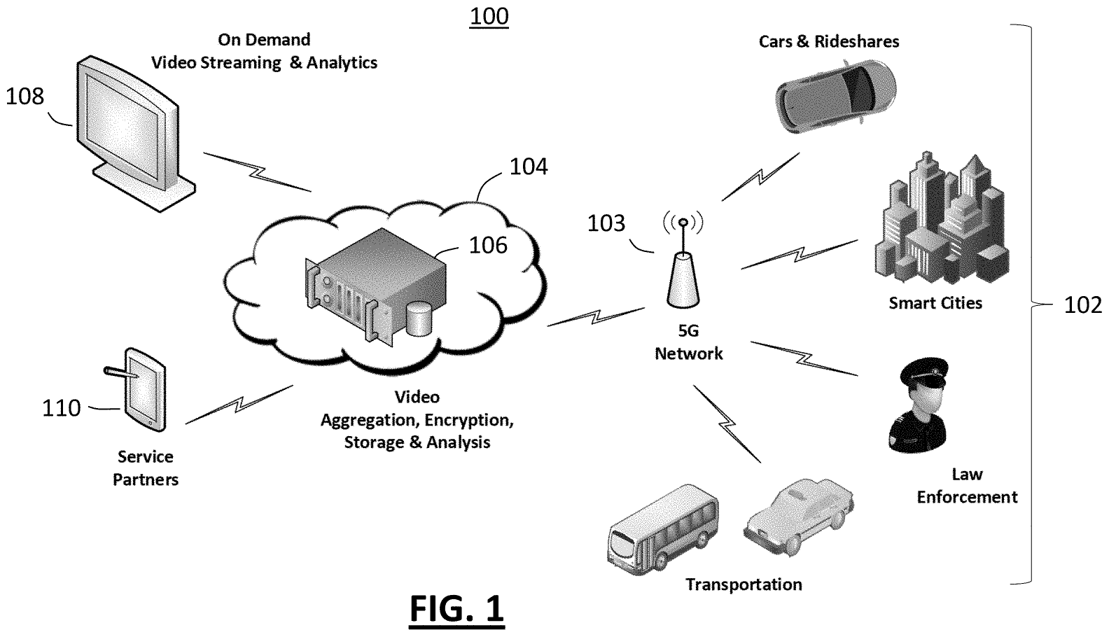

In accordance with certain embodiments, a video analytics system 100 is provided that can capture, store, catalog, search and display images (video and still) of events on demand. In certain embodiments, the system 100, shown generally in FIG. 1, presents a novel approach using a distributed camera network 102 that can include multiple cameras such as those mounted at city intersections and other public or private locales, worn by law enforcement and security, or mounted in public or private vehicles. In certain embodiments, some or all of the cameras in the network 102 can act as processors to accelerate and improve the overall performance of the system and the sophisticated video analytics functions it provides, thus implementing a system for programmable software-defined distributed processing or analytics as described herein.

In system 100, images (video and still) captured by the cameras of network 102, and, in certain embodiments, other images previously captured, are transmitted over cellular (e.g., 5G) and/or other wireless or wired networks 103 to a remote cloud computing system 104 that supports an electronic video analytics (EVA) platform 106 for video aggregation, encryption, storage and analysis. The system 100 is able to provide on demand video streaming and analytics to various users 108 and service partners 110.

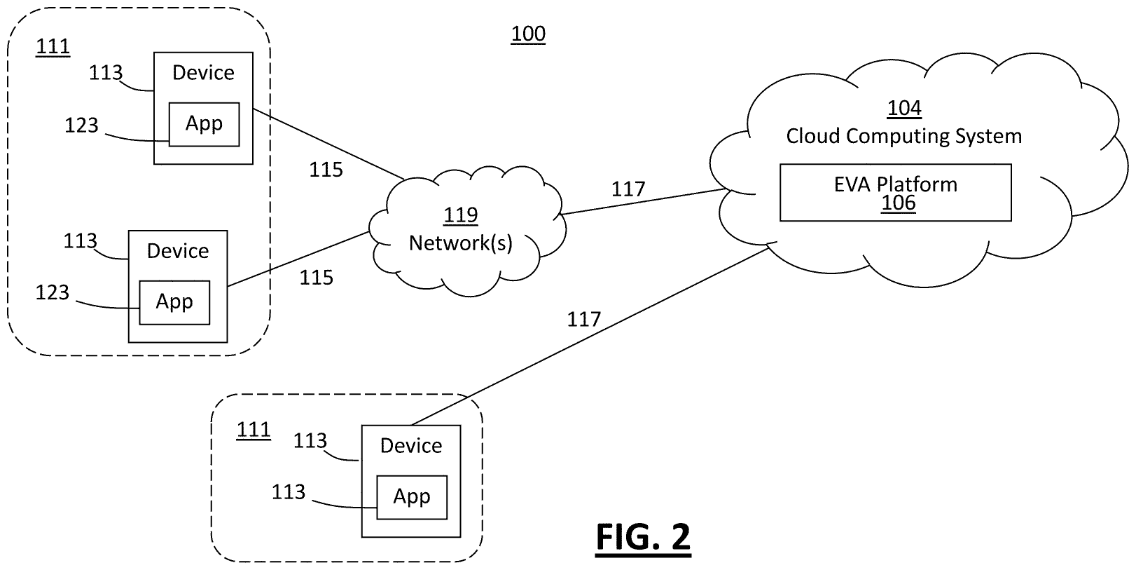

FIG. 2 is a cloud service system diagram of the system 100 in accordance with certain embodiments. In system 100, client users 111 may be organizations such as law enforcement agencies having one or more users that are each associated with a computing device 113. Each computing device 113 may be dynamically configured to run an application 123. The computing devices 113 are coupled over communication links 115 and/or 117, and optionally over one or more data networks 119, to remote cloud computing system 104. Any of components 115, 117, 119 or 121 may fully or partially reside in, or be connected to, the Internet. Data network 119 may be any type of data network or combination of data networks covering a local area, medium area or large area (such as the Internet). Communication links 115 and 117 may be wired or wireless or a combination of these.

EVA platform 106 may be implemented on one or more computing devices, for example servers (not shown), and are communicatively coupled to applications 123 over data network(s) 119 and connections 115 and 117. Although shown in terms of a cloud service system in FIG. 2, one will appreciate from the disclosure herein that the system may be configured in other manners including a hybrid cloud. For example, certain users may require a hybrid cloud such that select information is not stored in the cloud. This may be determined by rules in certain highly regulated industries and/or user needs and preferences.

The computing devices on which the system 100 is partially or completely executed may be any type of processor or control logic or circuitry including but not limited to one or more microprocessors on one or more devices at the same or different locations, with access to computer-readable memory (not shown) that may be any type of computer-readable memory, such as, random access memory (RAM), read only memory (ROM), or flash memory, provided on one or more devices. System 100, including remote cloud computing system 104 (and its components) may be implemented in software, firmware, hardware or any combination thereof and may be implemented on one or more computing devices at the same or different locations. Thus layered and/or distributed compute power may be used to implement system 100 in certain embodiments. Cloud computing system 104 including EVA platform 106 may be configured as a computer-implemented cloud service. In some examples, not intended to be limiting, a cloud service may be infrastructure, platforms, and/or software that are hosted by one or more providers and made available to users through the internet. For example, cloud computing system 104 may have web-based services, data storage, user registration, application services, communications, or other management functions to further support or complement platform 106 as part of a cloud service. The cloud service may be configured on private clouds, public clouds, hybrid clouds, and multiclouds.

In certain embodiments, the term application (such as application 123) refers to a desktop or laptop computer application, mobile device application, web application, browser, or browser extension. The applications provide user interfaces through which users are able to communication with the EVA platform to for example provide user-defined instructions as detailed below. For example, application 123 may be dynamically configured as an application installed on computing device 113 or may be a web application operated through a browser or browser extension on computing device 113 or a mobile phone application executing on Linux, IOS or Android operating system.

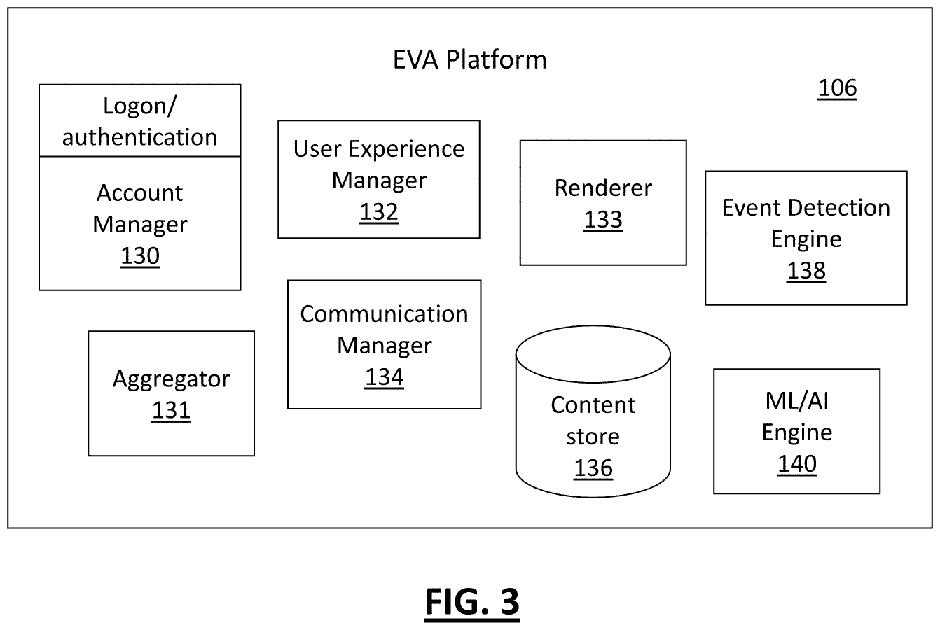

FIG. 3 is a block diagram showing some components of EVA platform 106. These include an account manager 130 for securely managing various client accounts and using a logon/authentication protocol; an aggregator 131 for aggregating video streams, such as for example event-containing videos as detailed below; a user experience manager 132 for handling the interaction between users and the platform 106; a renderer 133 for rendering videos, and particularly those flagged as containing events of interest as detailed below; a communication manager 134 for coordinating communications among the various components involved, within and outside the platform 106; a content store 136 providing a repository for content to be made available to clients based on control of the account manager 130, which may be based on subscriptions, purchases, etc; an event detection engine 138 that may be enlisted to detect events in captured video images as further detailed below; and a machine learning/artificial intelligence (ML/AI) engine 140 further described below. Content store 136 may be any type of data storage system including but not limited to one or more databases at the same or different locations.

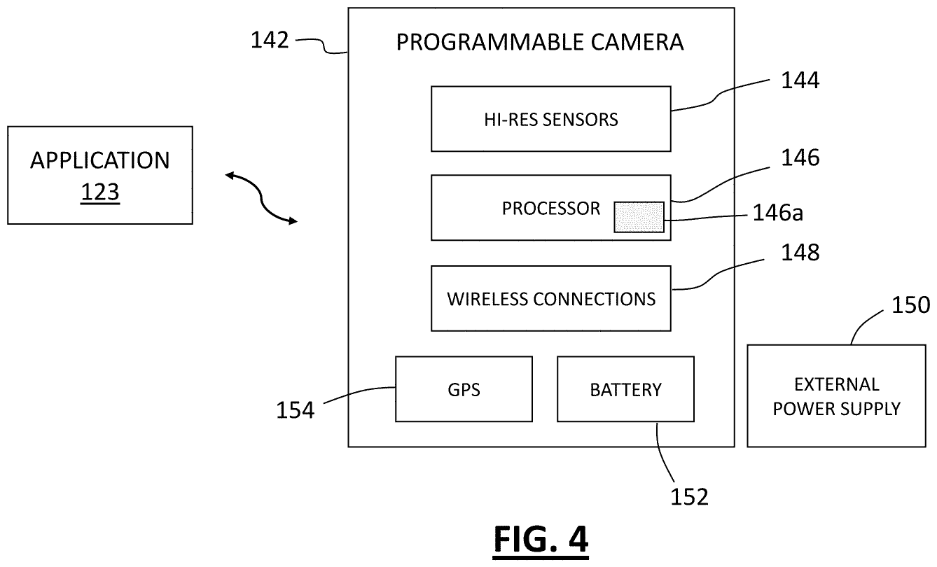

With reference to FIG. 4, a programmable camera device 142 comprising high-resolution sensors 144, high-performance processors 146 that may include an AI module 146a, and high-bandwidth network connections 148 is provided. According to one aspect, the connection is a 5G wireless connection and a wireless local area network (WLAN) router. The WLAN router (not shown) allows other devices, such as cameras or mobile phones, to join the private secure network to which the camera 142 is connected, and enables broadband access to the Internet and allows video sharing in real-time, in the manner illustrated in FIGS. 1 and 2. The camera device 142 has an external power source 150 and an internal battery 152 that can be rechargeable, and a GPS unit 154 that provides location information. As mentioned above, programmable camera device 142 can be mobile like a body camera used by law enforcement or stationery like a security camera used for surveillance in smart cities, home, or commercial real-estate.

Again with reference to FIGS. 1 and 2, the camera device 142 communicates with a mobile phone or other remote device executing an application 123 over a secure wireless connection, or any application or user interface that enables programming or exchanging information and instructions with the camera. The application allows authorized users to manage the camera device 142 and access data in system 100, for example data stored in content store 136 of platform 106 (FIG. 3). In certain embodiment, software defined camera processing can be performed, whereby users can change the type of processing performed by processor 146 of the camera by deploying new code pushed to all or a subset of cameras of camera network 102. Management of the device 142 can also include instructing the camera via the application 123 to selectively capture video imagery as described below. More generally, such selective capture enables a user to identify to the camera features or events warranting particular attention. For example, certain features of interest can be sought and captured, and others ignored; or features of interest can be captured in higher resolution than others. Within captured images or particular frames, portions of interest may be captured at higher resolution. For example, facial features of a subject can be captured at higher resolution than the torso; or hands can be captured at higher resolution than the arms or remainder of the body; or the subject can be captured in his/her entirety at higher resolution, whereas the background can be captured in lower resolution, or vice versa, and so on. This selectivity can be time or event dependent—for example, after sunset, or upon the occurrence of an activity such as locking of a premises gate or vehicle door. Managing the cameras 142 in this manner can reduce the amount of video that is captured and that needs to be transmitted and stored remotely, and subsequently analyzed. This technological improvement reduces computational burden, transmission speeds and bandwidth requirements, among other advantages.

In certain embodiments, AI powered variable compression on regions of interest in a frame can be performed, utilizing AI module 146a or ML/AI engine 140, or a combination of these. In one example, high resolution for faces and lower resolution for background can be thus implemented.

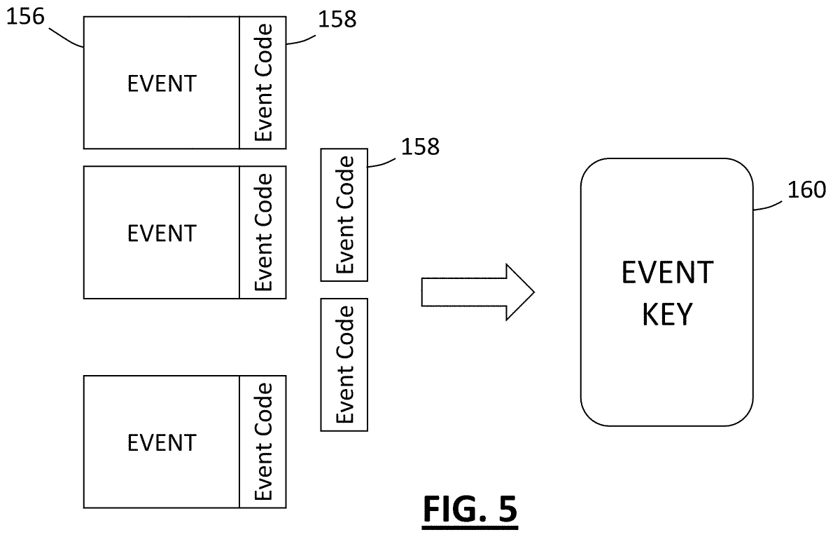

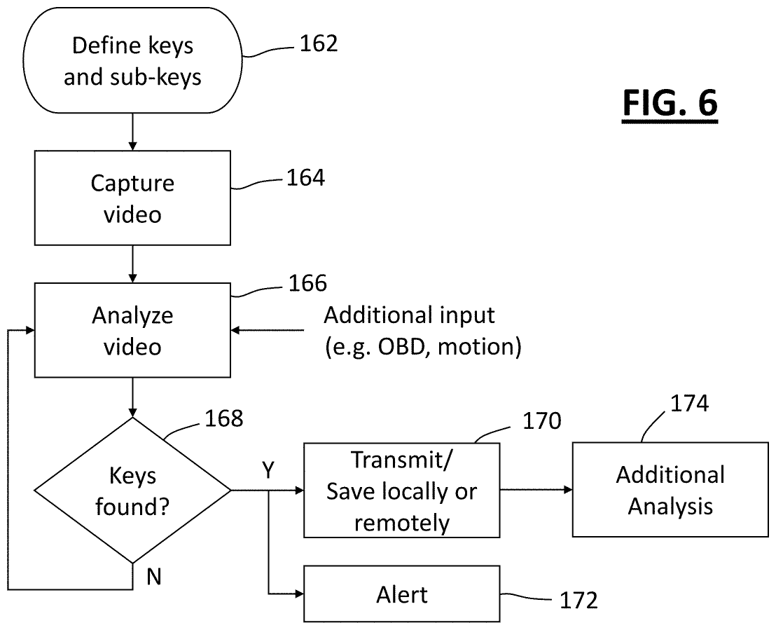

According to certain embodiments, and with reference to FIGS. 5 and 6, the camera device 142 can be programmed to look for events in video frames on the fly. Events 156 are software defined, using event detection engine 138 (FIG. 3) and in some embodiments, user input, so that the camera 142 can adapt to specific requirements and applications. In certain embodiments, engine 138 assigns a unique code 158 to each event. When an event or sequence of events of interest are detected—that is, encountered by the camera 142—an event key 160 is generated using a unique function of event codes 158. The function and codes are chosen, for example in a software-defined manner, in such a way that a key can be a subset of a larger key. Keys can thus represent events, and sub-keys represent subsets of events. Indexing of events can be using full keys or sub-keys. The keys 160 facilitate subsequent searching of captured videos or video segments. In certain embodiments, Boolean terms can be used for searching (e.g. search for video that has a cat and a couch).

Keys 160 can be used to reduce the amount of data being transmitted, searched, compressed and/or stored. Captured video is analyzed, and footage corresponding to a sequence of events of interest is tagged with a key 160 and, in certain embodiments, geolocation information from GPS module 154 is appended. In certain embodiments, the analysis of the captured video is performed remotely at a server (not shown), either completely or partially, in conjunction with the analysis at the camera 142. In certain embodiments, the keys are AI powered and can be used to determine compression levels, storage rules, and timeframes. They can also be used to speed up indexing (search for a key and look up video associated with key).

The video recording from the camera can be encrypted before transmitting it over the network to storage and/or analysis servers in the cloud. Aggregator 131 is used in certain embodiments to aggregate event-containing videos for storage on server 136 and for subsequent rendering by renderer 133. All video recording may have a predetermined, fixed length to facilitate indexing of storage and retrieval from databases such as content store 136. According to certain embodiments, components or frames of the video recording can be alternatively transmitted so that the video footage can be reconstructed later by renderer 133. In certain embodiments, a storage server 136 is comprised of an array of high-performance drives like NVMe (non-volatile memory) solid state drives, a high-performance database management system like SQL, and analytics network application. The database system 136 is used for video storage and additional analysis. An API in user experience manager 132 provides users with the ability to access the database over the network. The event key 160 generated by event detection engine 138 allows searching for any sequence of events in the database 136 quickly, hence eliminating the need to perform extensive post-recoding analysis.

In certain embodiments, technological improvements are realized whereby meta data is extracted using AI-powered camera 142 and is used as input to user-definable rules that determine how that data should be handled—for example, whether and where it should be stored, implementing rules-based storage, to thus optimize data storage, for example onboard the camera or in other portions of the cloud, or a combination. AI powering of the camera 142 may be via module 146a, or in other portions of the cloud in conjunction with ML/AI engine 140, or a combination of these, in a layered or distributed manner. This provides the technological improvement of reducing the amount of AI power required to be performed in camera 142 by module 146a, which does not have virtually unlimited horsepower in the manner that cloud-based ML/AI engine 140 could.

FIG. 6 is a flow diagram showing the operation of system 100 in performing an analysis of captured video. At 162, keys and sub-keys 160 may be defined. For example by event detection engine 138. At 164, video images (moving or still) are captured. Additional information may also be provided, for example an on board diagnostics output of a vehicle as described below. The video and information are analyzed at 166, searching for keys at 168 in particular in a looping manner. When a key is found, the video or relevant portions thereof are transmitted to a user and/or stored by the system locally or remotely at 170, and optionally, alert(s) are generated at 172. Additional analysis may also be performed, for example on the transmitted/stored video, at 174.

In certain embodiments, system 100 can implement AI powered algorithms for capturing specific frames or sequences of frames and transmitting them for further processing, analysis and storage in the cloud.

The potential of applications of the described embodiments range from transportation safety to law enforcement. One application, for example, is to further enhance security in taxi or rideshare services. An increasing number of drivers are using dashboard cameras to provide evidence that protects both drivers and passengers. Typically, dashboard cameras record video to a local memory card that has limited capacity and can be tampered with easily. The systems described herein can provide secure cloud storage for safekeeping evidence. In addition, it can be to recognized distressing situations, to the driver or passenger for instance, by facial recognition of distress markers for instance, or other biometric information, such a distressed voice or command for help or other voice commands.

According to certain embodiments, a camera such as camera 142 can detect drivers or passengers in distress and alert security monitoring services to dispatch help. This can be achieved by correlating facial and voice data to help enhance the safety of passengers, and can be performed by event detection engine 138. The camera 142 and event detection engine 138 can also perform facial recognition on passengers and clear results against a “no ride list” to enhance the safety of drivers.

Rideshare services allow drivers and passengers to review each other's ratings using the service mobile application in advance. The systems described herein enhance this capability by allowing passengers to also view the inside of the vehicle in advance. The camera allows drivers and passengers to visually communicate, increasing the level of trust between all parties. Once inside the vehicle, passengers can access the camera feed over a secure connection allowing them to see what the camera is recording.

According to certain embodiments, the camera accepts voice commands from authorized users. A voice command, for example, can tell the camera to take a photograph, take a video clip, or stream live video on social media for sharing with friends. Since the camera has mobile network connectivity, it can call for help in case of an emergency.

In modern vehicles, an on-board diagnostics (OBD) computer monitors emissions, mileage, speed, and other data about the vehicle. According to certain embodiments, a wireless dongle can be used to transmit diagnostics data to the camera device 142 in the vehicle. When enabled, the diagnostics data is associated with the video footage captured by the camera device. The correlation between video footage and diagnostics data can be very useful for training purposes, operational efficiency, or incident investigations. According to certain embodiments, the camera device can recognize road signs and conditions to alert vehicle operators to any driving deviations.

According to certain embodiments, the diagnostics data may include vehicle carbon emission measurements. The systems described herein can help manage and mitigate climate impact by providing real-time carbon footprint for any geographic area.

A vehicle alarm is an essential security system that tends to be available on most modern vehicles. It typically requires the intruder to break open the vehicle to be activated. The systems described herein further enhance the capabilities of vehicle alarm systems using one or several camera devices 142 positioned strategically on the vehicle. According to certain embodiments, when a camera device is activated by a motion sensor, it can send mobile text messaging alarm or other forms of alarms directly. The camera device can also generate sound or visual alarms to deter intruders. The real-time video feed analyzed by platform 106 allows the vehicle owner to assess the severity of the alarm and act accordingly.

Cameras are commonly used to provide security in home or commercial buildings. Usually, cameras are positioned to monitor specific areas like entrances or hallways. The video footage is time correlated to card access activities. According to certain embodiments, the camera can for example use event detection engine 138 to perform facial recognition on the person attempting access and correlate the results with card access system records so that operators can be notified immediately of any security breaches.

A unique aspect of the systems described herein is the aggregation of video data using a distributed programmable camera network and utilization of such data to enable emerging applications in security, autonomous driving, social media, and law enforcement to name a few. The aggregated data can be used for creating or perfecting models used in artificial intelligence (AI) and machine learning (ML). The data can also be made available to third parties by enabling a consent feature which allows the data to show up in search queries.

### Further Embodiments

Aspects of the embodiments of the system 100 (and its components) may be implemented electronically using hardware, software modules, firmware, tangible computer readable or computer usable storage media having instructions stored thereon, or a combination thereof and may be implemented in one or more computer systems or other processing systems.

Embodiments may be directed to computer products comprising software stored on any computer usable medium. Such software, when executed in one or more data processing device (also called a computing device), causes a data processing device(s) to operate as described herein.

Various embodiments can be implemented, for example, using one or more computing devices. A computing device can be any type of device having one or more processors and memory. For example, a computing device can be a workstation, mobile device (e.g., a mobile phone, personal digital assistant, tablet or laptop), computer, server, computer cluster, server farm, game console, set-top box, kiosk, embedded system, or other device having at least one processor and memory.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A video analytics system comprising:
a camera network for capturing one or more videos; and
an EVA platform, coupled to the camera network, operable to perform one or more of video aggregation, encryption, storage and analysis, the EVA platform including:
a content store for storing videos of the one or more captured videos,
an event detection engine for defining one or more events that are each assigned a unique key when encountered in a video of the one or more captured videos,
an aggregator for aggregating event-containing videos, and
a renderer for rendering the event-containing videos.

2. The system of claim 1, wherein the event detection is software-defined.

3. The system of claim 2, wherein the event detection engine defines an event based on user input.

4. The system of claim 1, wherein the EVA platform is configured to implement rules-based storage of captured videos.

5. The system of claim 4, wherein the rules-based storage is based on extracted meta data.

6. The system of claim 1, wherein the EVA platform is configured to perform AI powered variable compression of captured videos.

7. The system of claim 6, wherein said AI powered variable compression defines one or more of compression level, storage rules, or timeframe.

8. The system of claim 7, wherein said AI powered variable compression defines portions of captured video to compress.

9. A system comprising:
one or more programmable cameras for capturing video; and
an EVA platform configured to enable users to provide, using applications on remote computing devices accessed through user interfaces, user-defined instructions over a data network for performing one or more of AI-powered software-defined compression, storage, processing, or searching.

10. The system of claim 9, wherein said software-defined searching relates to real time analytics to identify irregular or undesired events which are either appearance or behavior of individuals, or animate or inanimate objects in the captured video.

11. The system of claim 9, wherein said software-defined compression defines one or more of compression level, storage rules, or timeframe.

12. The system of claim 9, wherein said software-defined compression defines portions of captured video to compress.

13. The system of claim 9, wherein said software-defined storage defines events of interest.

14. The system of claim 13, wherein said events of interest are assigned unique keys.

15. A method for performing analysis of captured video comprising:
defining one or more keys each uniquely corresponding to a video event;
capturing one or more videos;
identifying at least one event in a portion of a first captured video;
assigning to the portion a key of the one or more keys;
conducting rules-based processing of the first captured video such that the portion to which the key is assigned is processed differently than other portions of the first video or other captured videos,
wherein said rules-based processing is performed by an EVA platform configured to enable users to provide, using applications on remote computing devices accessed through user interfaces, user-defined instructions over a data network for performing one or more of AI-powered software-defined compression, storage, processing, or searching of the captured one or more videos.

16. The method of claim 15, wherein said rules-based processing is defined by a user.

17. The method of claim 15, wherein the event detection is software-defined.

18. The method of claim 15, wherein the EVA platform is configured to implement rules-based storage of captured videos.

19. The method of claim 18, wherein the rules-based storage is based on extracted meta data.

20. The method of claim 15, wherein the EVA platform is configured to perform AI powered variable compression of captured videos.
